(19) United States
(12) Patent Application Publication
(10) Pub. No.: US 2003/0223006 A1
(43) Pub. Date: Dec. 4, 2003

(54) Image pickup apparatus, main subject determination apparatus and image processor

(75) Inventor: Eiichi Kito, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/449,508

(22) Filed: Jun. 2, 2003

(30) Foreign Application Priority Data
May 31, 2002 (JP) 2002-159118

(51) Int. Cl. H04N 5/222

(52) U.S. Cl. 348/333.03

(57) ABSTRACT

An image pickup apparatus of the invention is for example a video camera, which has: a solid-state image pickup device, a display which shows a scene to be confirmed by a photographer for a record, the scene shot by the solid-state image pickup device, line of sight detection section for detecting a line of sight of the photographer toward a main subject of the scene on the display, and recording section for recording the image data of a shot moving image and at least one of first information on the detected line of sight and second information on the main subject detected from the first information onto a recording medium, the image data and at least one of the first information and the second information corresponding each other. The apparatus can also has a detection section for detecting the main subject of a shot moving image.

An image processor of the invention has a function which determines a main subject of an image, and processes the image based on the main subject using a image data of the image and the main subject information which are recorded on the recording medium.

### BACKGROUND OF THE INVENTION

1. Field of the Invention

This invention belongs to the art of image pickup apparatus, main subject determination apparatus preferably used by the image pickup apparatus, and an image processor for processing the image data of an image shot by the image pickup apparatus, and more particularly, relates to image pickup apparatus, main subject determination apparatus and an image processor which can extract a main subject from an image, especially a moving image and perform a variety of image data processing on the extracted main subject.

2. Description of the Related Art

Today, home video cameras are in widespread use and shooting of moving images by general users is popular at several types of events such as a field day and wedding ceremony.

Moving images shot by a general user who is not professional often includes useless scenes where a main subject is not found or failure. Thus, all the shot images are not necessary those which the user does not want to be viewed later. Important scenes may not always contain an image of the main subject properly.

In the meantime, a variety of computer software applications or systems are on the market whereby the image data of an image shot with a digital video camera or an image shot with an analog video camera converted to digital image data is captured into a computer and edited/corrected.

It is well known that image data, especially the image data of a moving image has a huge data amount. Thus it takes time to find a target scene or important scenes out of a shot moving image. This results in cumbersome work of editing and management of image data. For such reasons, in most cases, image data is just stored without being edited once it is viewed.

For a still camera, in most cases, an image data is judged to be proper as long as a main subject is properly viewable. In association with this, for example, the JP08-328126 A proposes a camera equipped with a line-of-sight detecting function which detects the position of a subject (area where the subject is present) by way of line-of-sight detection in a finder and records the subject area information on a magnetic recording medium of a photographic film in accordance with the result of detection, and discloses that exposure is controlled so as to reproduce the subject area image based on this information.

However, there is no such a mechanism concerning the image data of a moving image.

At present, processing of the image data of a moving image such as storage/management of image data, editing/correction of images, reproducing moving images and printing images are very cumbersome. As a result, the data of a moving image shot with a video camera is stored without editing once it is viewed. Precious image data is not fully utilized, which causes to be useless storage sources.

### SUMMARY OF THE INVENTION

An object of the invention is to solve the problems of the prior art and aims at providing image pickup apparatus which can extract the main subject of an image from image data, especially the image data of a moving image, efficiently edit or reproduce moving images (image data) focused on important scenes, store/manage the image data, and print out the image by using the information on the main subject, that is, make good use of precious image data, main subject determination apparatus preferably used by this image pickup apparatus, and an image processor which can efficiently process the data of an image shot with the image pickup apparatus.

This invention provides an image pickup apparatus comprising: a solid-state image pickup device, a display which shows a scene to be confirmed by a photographer for a record, the scene shot by the solid-state image pickup device, line of sight detection means for detecting a line of sight of the photographer toward a main subject of the scene on the display, and recording means for recording the image data of a moving image shot by the solid-state image pickup device and at least one of first information on the line of sight detected by the line of sight detection means when the moving image was shot and second information on the main subject detected from the first information onto a recording medium, the image data and at least one of the first information and the second information corresponding each other.

The image pickup apparatus preferably has the line of sight detection means which has: a light source which emits infrared light toward an eye of the photographer, a light splitter which divides the infrared light reflected on the eye of the photographer and a visible light, a focusing lens which focuses the divided infrared light, and a sensor which senses the focused infrared light on a light receiving surface. Then the light receiving surface of the sensor and a displaying surface of the display are preferably arranged in optically equivalent positions with respect to an optical axis of the focusing lens.

It is also preferable that the first information on the line of sight is information on a position of an eye-cast point of the photographer on a displaying surface of the display.

This invention also provides a main subject determination apparatus comprising: a solid-state image pickup device, a display which shows a scene to be confirmed by a photographer for a record, the scene shot by the solid-state image pickup device, line of sight detection means for detecting a line of sight of the photographer toward a main subject of the scene on the display, and detection means for detecting the main subject of a shot moving image from a image data of the moving image shot by the solid-state image pickup device and first information on the line of sight detected by the line of sight detection means when the moving image was shot.

The main subject determination apparatus preferably has the line of sight detection means which has: a light source which emits infrared light towards an eye of the photographer, a light splitter which divides the infrared light reflected on the eye of the photographer and a visible light, a focusing lens which focuses the divided infrared light, and a sensor which senses the focused infrared light on a light receiving surface. Then the light receiving surface of the sensor and a displaying surface of the display are preferably arranged in optically equivalent positions with respect to an optical axis of the focusing lens.

It is preferable that the first information on the line of sight is information on a position of an eye-cast point of the photographer on a displaying surface of the display.

This invention still also provides an image processor comprising: acquisition means for acquiring the image data of a photoelectrically shot image and first information on a line of sight of a photographer toward a main subject of the image when the photographer shot the image; and determination means for determining the main subject from an image carried by the image data by using the image data and the first information acquired by the acquisition means.

In the image processor, it is preferable that the line of the sight is detected by an apparatus which has: a light source which emits infrared light towards an eye of the photographer,

a light splitter which divides the infrared light reflected on the eye of the photographer from a visible light, a focusing lens which focuses the divided infrared light, and a sensor which senses the focused infrared light on a light receiving surface.

Then the light receiving surface of the sensor and a displaying surface of the display are preferably arranged in optically equivalent positions with respect to an optical axis of the focusing lens.

It is also preferable that the first information on the line of sight is information on a position of an eye-cast point of the photographer on the shot image when the photographer shoots a scene. The image data may preferably be a data of a moving image. Then, more preferably, the first information on the line of sight acquired with the image data is corresponding to each frame of the moving image.

This invention provides an image processor comprising: extraction means for extracting an image where a main subject is on by using the image data of a photoelectrically shot image and first information on a line of sight of a photographer toward the main subject of the shot image; and image processing means for applying processing to the image data with a processing condition based on the extracted main subject.

In the image processor, the line of the sight is preferably detected by an apparatus which has: a light source which emits infrared light towards an eye of the photographer, a light splitter which divides the infrared light reflected on the eye of the photographer and a visible light, a focusing lens which focuses the divided infrared light, and a sensor which senses the focused infrared light on a light receiving surface. Then the light receiving surface of the sensor and a displaying surface of the display are preferably arranged in optically equivalent positions with respect to an optical axis of the focusing lens.

It is preferable that the first information on the line of sight is information on a position of an eye-cast point of the photographer on the shot image when the photographer shoots a scene.

In the image processor, the image data may be the image data of a moving image. Then the image processing means performs preferably at least one of the following processing types: image processing to reproduce an optimized moving image or an optimized still image of the main subject, image processing to reproduce a moving image with a processing condition based on a frame where the main subject is on, and selection of an index image based on the main subject.

In an image processor according to the first embodiment of the invention, the acquisition means preferably acquires the image data and line of sight information from a recording medium where the image data and the line of sight information associated with the image data are recorded, and the determination means preferably selects one or more candidates for a main subject and preferably uses the line of sight information to select the main subject from the candidates for the main subject.

The image data is preferably the image data of a moving image and the line of sight information is preferably associated per frame of the moving image.

In an image processor according to the second embodiment of the invention, the image data is preferably the image data of a moving image and the image processing means performs at least one of the following processing types: image processing to regenerate an optimized moving image or still image of a main subject, image processing to regenerate a moving image with particular emphasis on the frames where the main subject is present, and selection of an index image based on the main subject.

The selection of an index image based on the main subject refers to for example selection of a frame where the main subject first appears or a frame where the main subject appears largest. The image processing to regenerate a moving image with particular emphasis on the frames where the main subject is present refers to for example generation of image data where frames containing the main subject (and predetermined number of frames preceding and following the frames) are regenerated in normal speed and the remaining frames are fast-forwarded.

### BRIEF DESCRIPTION OF THE DRAWINGS

FIG. 1 is a conceptual block diagram showing an example of image pickup apparatus according to the invention;

FIG. 2 is a conceptual illustration explaining a main subject detecting method according to the invention;

FIG. 3A is a conceptual illustration explaining an example of a method for recording the image data of a moving image by way of the image pickup apparatus shown in FIG. 1;

FIG. 3B is a conceptual illustration explaining an example of a method for recording the image data of a moving image by way of the image pickup apparatus shown in FIG. 1;

FIG. 4 is a conceptual block diagram showing an example of a reproducing player which uses an image processor according to the invention; and

FIG. 5 is a conceptual block diagram showing an example of a main subject determination apparatus according to the invention.

FIG. 6 is a conceptual block diagram showing an example of a processing system which uses the image pickup apparatus according to the invention.

### DETAILED DESCRIPTION OF THE INVENTION

Image pickup apparatus, main subject determination apparatus, and an image processor according to the invention are described below in detail with reference to a preferred embodiment shown in the accompanying drawings.

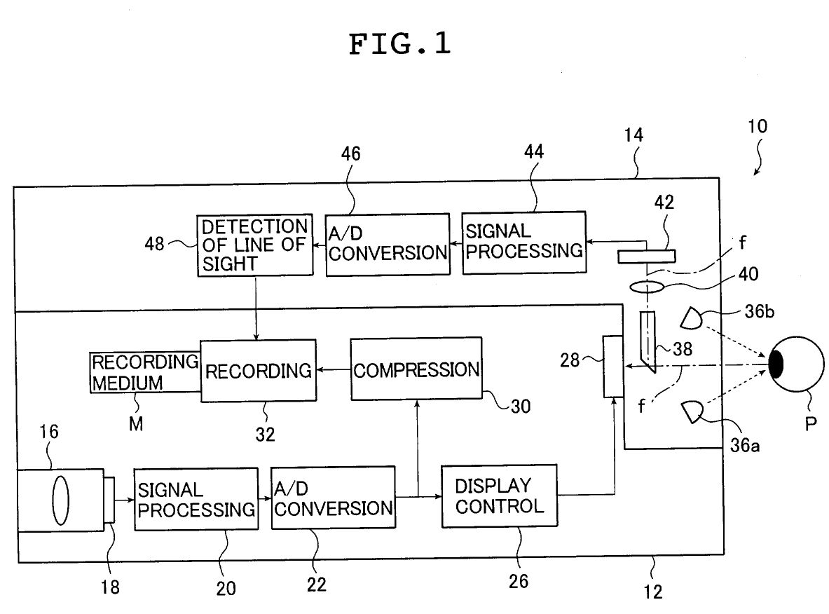

FIG. 1 is an exemplary conceptual illustration of image pickup apparatus according to the invention.

A camera (image pickup apparatus) 10 shown in FIG. 1 is a so-called digital video camera and basically comprises a shooting section 12 and a line of sight detecting section 14. The camera 100 records the line of sight information (the first information) of a photographer together with the image data of a shot moving image onto a recording medium M.

The shooting section 12 comprises an imaging lens unit 16, a CCD sensor 18 for shooting (hereinafter referred to as a shooting CCD 18), a signal processor 20, an A/D converter 22, a display controller 26, a liquid crystal display 28 (hereinafter referred to as an LCD 28), a compression processor 30, and a data recording section 32.

The shooting section 12 is basically the same as a regular digital video camera except for data recording onto the recording medium M by the data recording section 32.

The imaging lens unit 16 is an imaging lens unit having the zoom function and AF function (Auto Focus function) usually used in a video camera. The shooting CCD 18 is an area CCD sensor usually used in a video camera which reads a shot scene (image) by decomposing the scene into primary colors, R (red), G (green) and B (blue).

In the invention, the camera 10 may use a single CCD sensor to read the primary colors. Or, the camera 10 may use a single CCD sensor to read a single color, that is, the camera 10 may be a so-called 3-CCD-sensor camera.

Same as a regular video camera, a shot scene is focused on the light-receiving surface of the shooting CCD 18 by way of the imaging lens unit 16 and undergoes optoelectronic conversion.

The output signal from the shooting CCD 18 undergoes signal processing such as noise removal and darkness correction (darkness level correction) in the signal processor 20 and A/D conversion (analog-to-digital conversion) in the A/D converter 22 to become a digital image signal.

The digital image signal from the A/D converter 22 is supplied to the display controller 26 and the compression processor 30.

The image signal supplied to the display controller 26 undergoes tone conversion, color/density correction and known image processing such as data conversion in the display controller 26. After that, the image signal is converted to image data for display on the LCD 28. The shot scene is displayed on the LCD 28 which is the finder of the camera 10 (a display showing a scene to be confirmed by a photographer).

The finder of the camera 10 according to the invention is not limited to an LCD but various types of display means such as a CRT (Cathode ray Tube) may be used.

The image signal supplied to the compression processor 30 is converted to for example general Y, U and V signals and, after the image is enhanced, sorted as an moving image and compressed in accordance with the MPEG (Motion Picture Expert Group) format. The resulting image is output to the data recording section 32 as image data of a moving image in the MPEG image file format.

The image file format of a moving image is limited to MPEG in this invention. For example, a variety of image file formats may be used, such as AVI (Audio Video Interlaced). WMV (Windows Media Video), and QT (Quick Time).

The line of sight detecting section 14 is a portion which detects which area of the LCD 28 as a finder the eyeball P of the photographer is watching, that is, the line of sight of the photographer in photographic shooting. The line of sight detecting section 14 basically comprises infrared LEDs 36a and 36b, a light splitter 38, an focusing lens 40, an area CCD sensor 42 for detecting the line of sight (hereinafter referred to as a line-of-sight CCD 42), a signal processor 44, and a line of sight detecting unit 48.

Both the infrared LEDs 36a and 36b are known LEDs which emits an infrared light. Theses LEDs are arranged in symmetric positions with respect to the optical axis f of the imaging lens 40 so as to emit an infrared light on the eyeball P of the photographer.

The light splitter 38 is a member which splits a light into a visible light and an infrared light and directs the infrared light toward the focusing lens 40. In the shown example, a dichroic mirror which transmits a visible light and reflects an infrared light is arranged 45 degrees tilted against the optical axis f and with the reflective surface directed toward the eyeball P so as to transmit an infrared light reflected on the eyeball P toward the focusing lens 40.

The infrared light reflected by the light splitter 38 is focused on the light-receiving surface of the line-of-sight CCD 42 by the focusing lens 40. The line-of-sight CCD 42 is a single-color area CCD sensor which is sensitive to an infrared light.

In the shown example, the LCD 28 is arranged with its center pixel positioned on the extension line of the optical axis f of the focusing lens 40 and with the observation surface orthogonal to the extension. The line-of-sight CCD 42 is arranged with its center pixel positioned on the extension line of the optical axis f of the focusing lens 40 and with the light-receiving surface orthogonal to the optical axis f. The LCD 28 and the line-of-sight CCD 42 are arranged so that the direction of arrangement of pixels will be optically aligned with the optical axis f. That is, the LCD 28 as the finder of the camera 10 and the line-of-sight CCD 42 are arranged in optically equivalent positions with respect to the optical axis f.

The output signal from the line-of-sight CCD 42 undergoes signal processing such as noise removal and darkness correction in the signal processor 44 and A/D conversion in the A/D converter 46 to become a digital image signal, then output to the line of sight detecting unit 48.

The line of sight detecting unit 48 is a portion which analyzes an image read by the line-of-sight CCD 42, that is, an image emitted from the infrared LEDs 36a and 36b, reflected on the eyeball P of the photographer, and focused on the line-of-sight CCD 42, and detects the line of sight of the photographer.

As mentioned earlier, the infrared LEDs 36a and 36b are arranged in symmetric positions with respect to the optical axis f of the imaging lens 40.

Thus, the incidence positions of an infrared light emitted from the infrared LED 36a and 36b and reflected on the cornea of the eyeball P onto the line-of-sight CCD 42, the incidence position of an infrared light emitted from the infrared LEDs 36a and 36b and reflected on the ends of the iris of the eyeball P onto the line-of-sight CCD 42 varies with the angle variation of the center line of the eyeball P (eyeball optical axis), that is, the line of sight. As mentioned earlier, the LCD 28 and the line-of-sight CCD 42 are arranged in optically equivalent positions with respect to the optical axis f.

Thus, by detecting and analyzing the position of each of the characteristic points (lights projected onto the cornea and iris) projected onto the line-of-sight CCD 42, it is possible to detect the line of sight of the photographer in the LCD 28 as a finder.

Such a line of sight detecting method is detailed in the JP05-333259A.

In the invention, a method for detecting the line of sight of the photographer in the camera 10 is not limited to this method. For example, a method for detecting the line of sight by aligning the optical path of an infrared light from an infrared light source with the optical path the displayed image reaches the eyeball of the observer (photographer) by using a dichroic mirror, transmitting the infrared light toward the eyeball of the observer, forming the resulting image of the eyeball onto a photo-detection device, and analyzing the image to detect the line of sight, disclosed in the JP08-179223A may be used. Another method to be used is one for projecting the parallel luminous flux onto the anterior section of the eyeball of the observer and using the image reflected on the cornea by way of the reflected light from the cornea and the image forming position on the pupil to obtain the axis of sighting, as disclosed in the JP01-274736A.

As mentioned earlier, an image shot with the shooting CCD 18 undergoes predetermined processing and is output to the data recording section 32 as an MPEG-format image file. The result of detection of line of sight of the photographer (eyeball P) by the line of sight detecting unit 48 is also output to the data recording section 32.

The data recording section 32 records onto a recording medium M a single frame of an MPEG-format image file and the information on the line of sight of the photographer (hereinafter referred to as line of sight information) in shooting of the frame in association with each other.

The line of sight information is not particularly limited. For example, a method for indicating the position of the line of sight per frame by using the coordinates on a shooting screen coordinates of an eye-cast point on a screen and other methods may be used. An exemplary preferable method is described below.

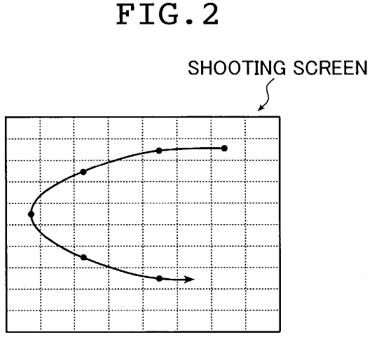

As schematically shown in FIG. 2, a shooting screen is previously divided into a plurality of small regions and the result of detection of the line of sight (position of an eye-cast point) by the line of sight detecting unit 48 is associated with the position of each small region (address). A small region where the line of sight of the photographer is present is detected per frame of a shot moving image and assumed as line of sight information. Each frame and the line of sight information are recorded onto a recording medium M in association with each other.

A method for recording the image data of a moving image and line of sight information is not particularly limited but various methods may be used. In the shown example where the image data of a moving image is an MPEG-format image file, the MPEG file format is preferably used to record an image file and the corresponding line of sight information.

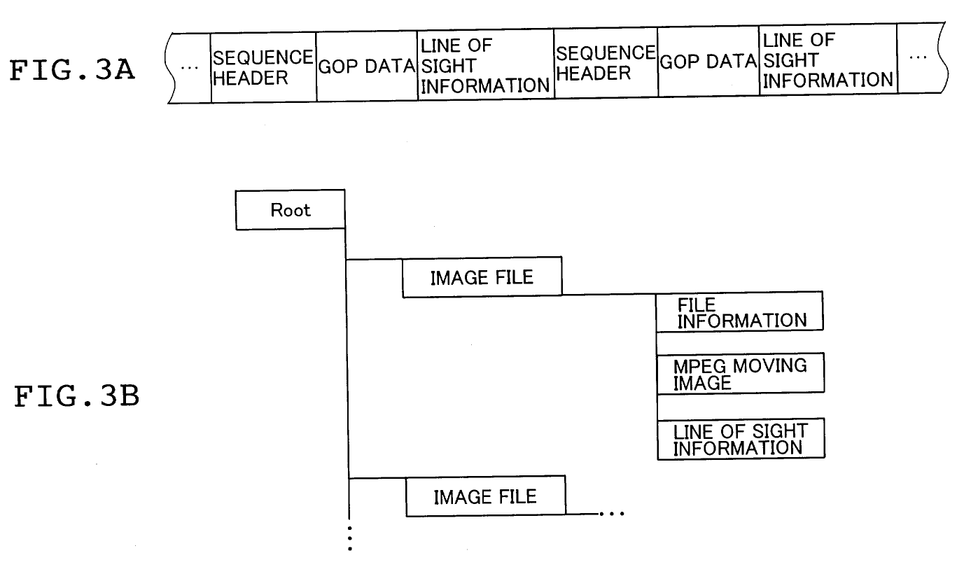

FIG. 3A is a conceptual illustration of its example.

As everyone knows, an MPEG-format image file uses the GOP (Group of Pictures) structure as a combination of I Picture (Intra-coded Picture), P Picture (Predictive-coded Picture), and B Picture (Bidirectionally Predictive-coded Picture) and comprises repetition of GOP data and a sequence header.

One GOP typically records 0.5 seconds (15 frames) of data. As shown in FIG. 3A, for example after the GOP data in a single GOP section delimited by a sequence header, the line of sight information of each frame recorded in this section is added to configure an image file.

Alternatively, the image data of a moving image and the line of sight information may be recorded as a separate file.

For example, as shown in FIG. 3B, concerning a single image file of a moving image, a file containing file information, an MPEG-format moving image file, and a file containing line of sight information may be generated and data corresponding to the respective files is recorded to configure an image file.

In the invention, the camera 10 may be a digital camera which can record both a moving image and a still image. To record both a moving image and a still image onto a recording medium M, associated line of sight information is to be recorded for both the moving image (frame) and the still image.

The recording medium M onto which the camera 10 records information is not particularly limited. Various recording media onto which a digital video camera records a moving image may be used, including a video tape, a DVD (DVD-RAM, DVD-RW), a CD (CD-R, CD-RW), an IC memory, and a HD (Hard Disk).

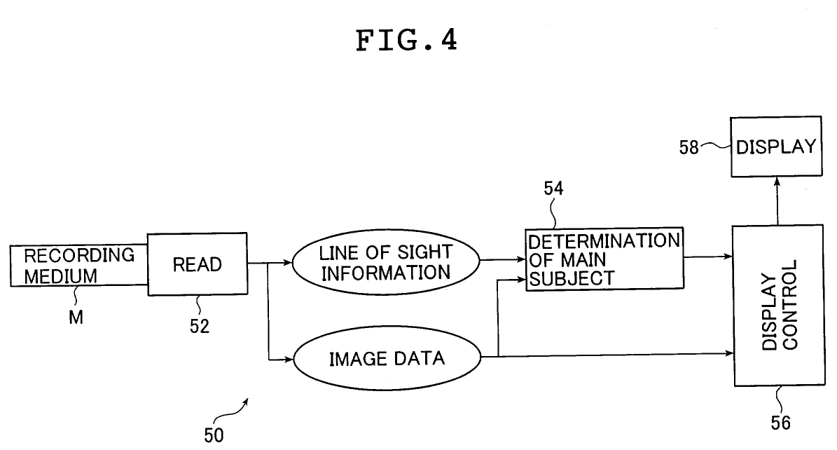

FIG. 4 is a conceptual block diagram showing an example of a reproducing player which uses the image processor according to the invention to reproduce an image shot with the camera 10 of the invention.

The reproducing player 50 shown in FIG. 4 reads image data and line of sight information from a recording medium M on which the image data of a shot image and the line of sight information of the photographer who shot this image are recorded, such as a recording medium M on which an MPEG-format image file and line of sight information are recorded in association with each other by the camera 10, applies various types of processing, and displays the image file. The reproducing player 50 basically comprises a data reading section 52, a main subject determination section 54, a display controller 56, and a display section 58.

The data reading section 52 comprises a drive compatible with a recording medium M The data reading section 52 is an area which reads recorded data from the recording medium M and discriminates image data (MPEG-format image data of a moving image for the camera in FIG. 1) from line of sight information, and supplies the line of sight information to the main subject determination section 54 and the image data to the main subject determination section 54 and the display controller 56, respectively.

The main subject determination section 54 (hereinafter referred to as a determination section 54) is a portion which uses line of sight information to determine the main subject of an image and supplies the main subject to the display controller 56.

In shooting of a moving image with a vide camera, the photographer usually tracks the most important subject to be shot, that is, the main subject, with his/her line of sight and tries to shoot an image so as to provide the most favorable shot for the main subject. By using the line of sight information, it is possible to correctly determine the main subject of a moving image. As mentioned later, this determination is used for various types of processing to be efficient, which enables effective use of the image data of a moving image.

The determination section 54 first extracts possible main subjects from the image.

A method for extracting possible main subjects is not particularly limited but various methods may be used. An exemplary method for using contour lines to reduce data amount of extracted possible main subjects is disclosed in the JP05-307537A. In this method, a significant point in the image is set, a line segment in a predetermined direction around this significant point is detected, a high-continuity line segment and a high-intensity line segment are cooperatively emphasized in a direction approximately identical with the predetermined direction as well as a low-continuity line segment and a low-intensity line segments are erased under contention thereby extracting the contour line of a possible main subject.

Another method for extracting a possible main subject for a subject is disclosed in the JP06-158164A. According to this method, a two-dimensional histogram of hue and chroma is obtained from image data of primary colors; the two-dimensional histogram is chopped with a parallel plain to a coordinate plane containing the hue axis and chroma axis to obtain cross sections corresponding to peak areas in the histogram; exclusive expansion processing is applied to this section; cross sections are divided corresponding to the peaks at the boundary of processed section; the pixels are assigned to the groups of peaks to divide the image; and one or more possible main subjects are selected from the divided regions.

A variety of other subject extracting method may be used such as one for extracting a possible subject by using the continuity of pixels and one for extracting pixels where the same color is aggregated as a possible subject.

Once possible main subjects have been extracted, the determination section 54 uses the line of sight information to determine a possible main subject tracked by the line of sight of the photographer as a main subject, and outputs the information on the main subject to the display controller 56. For example, as mentioned earlier (FIG. 2), in case where the shooting screen is divided into small regions and a small region where the line of sight of the photographer is present is assumed as line of sight information, the main subject is determined by obtaining small regions enclosed by a possible main subject obtained through contour extraction and detecting a small region tracked by the line of sight.

As mentioned earlier, in shooting of a moving image with a video camera, the photographer usually tracks a main subject with his/her line of sight. Thus, according to the invention which uses line of sight information, it is possible to accurately determine a main subject.

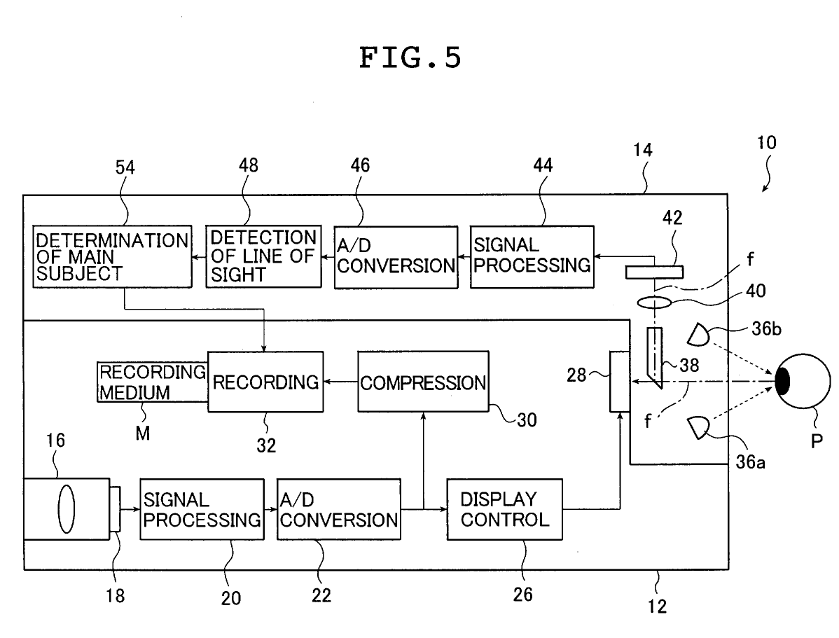

In the shown example, the camera 10 performs recording of line of sight information onto a recording medium. The main subject is determined using the line of sight information by the reproducing player 50. The invention is not limited to this configuration. The camera 10 may be configured to be a main subject determination apparatus, which uses the line of sight information and the image data of a moving image to determine a main subject and record the information on the main subject (the main subject information, the second information) in each frame onto the recording medium M as long as this approach is allowed in terms of the data processing speed, as shown in FIG. 5.

In an exemplary method, the contour of an object tracked by a line of sight is extracted as a main subject from the aforementioned line of sight detection result; and the contour information is recorded onto the recording medium M together with moving image data such as an MPEG-format image file mentioned earlier, in association with each frame as main subject information. Extraction of contour may use the method mentioned earlier.

In the determination of such a main subject, a frame (image) where any small region tracked by the line of sight is not found in the plurality of possible main subjects may be assumed as the main subject information indicating that “the main subject is not present.”

In case the main subject determined within a time unit (predetermined number of frames) varies since the line of sight frequently moves across the screen (the line of sight is unstable), the frame may be also assumed as the main subject information that the main subject is not present.

A same subject determined as a main subject over a predetermined number of frames in succession may be determined as a main subject and the other frames may be assumed as lacking in the main subject.

The display controller 56 processes the supplied image data with particular emphasis on the main subject information supplied from the determination section 54, and reproduces a moving image on the display section 58. A variety of displays such as an LCD and a CRT may be used as the display section 58.

An exemplary method for processing the image data with a processing condition based on the main subject is one for adjusting the density and color balance of an image so as to reproduce the main subject in the optimum state. For example, in case the main subject is a person, image density and color balance are adjusted to provide the image of the person's face with a beautiful skin tone. Such an image processing method may be a known method, such as one using matrix operation or using LUT (Lookup Table).

Also preferable is a method for processing image data and supplying the resulting data to the display section 58 to emphasize scenes where the main subject is present in reproducing of a moving image.

For example, a scene containing an object identified as a main subject is reproduced in normal speed, while a scene lacking in an object identified as a main subject, such as one determined as “the main subject is not present” due to a variation in the line of sight, is skipped or fast-forwarded in reproducing the moving image.

While only reproducing a moving image by the display section 58 is illustrated in the example shown in FIG. 4, a reproducing player using the invention may output a printed image by using the image data of a moving image. That is, a reproducing player according to the invention may reproduce the image of a processed image data as a hard copy.

A reproducing player of the invention may be a unit which reproduces a moving image (image) or outputs a printed image, or a unit which reproduces a moving image and outputs a printed image.

A printer to be used is not particularly limited but a variety of printers may be used.

Examples of such printers include a printer which imagewise exposes a photosensitive material (printing paper) with a recording light modulated in accordance with image data, applies a predetermined wet development process, and outputs a resulting print, a printer (such as Pictrostat from Fuji Photo Film Co., Ltd.) which uses a photosensitive material used to transfer an image onto an image receiving medium in the presence of an image forming solvent such as water, an ink-jet printer, and an electronic photography printer.

In this example, in case a scene in a moving image is to be printed, printing is made to provide an optimum image of a main subject for example, same as the foregoing example.

In particular, when a scene (frame) to be printed is specified, same as the foregoing example, a main subject is determined by the determination section 54 based on a combination of extraction of a contour and the line of sight information on the scene. Then, image processing is applied by a print image processor such as the display controller 56 so as to provide an optimum image of the main subject. The resulting image is sent to a printer to provide a printed image. In case the main subject is a person, image processing is made so as to provide an optimum image of his/her face.

Image processing to be applied is not particularly limited. Various types of image processing for reproducing a print (hard copy) may be used, such as color/density correction, tone correction, chroma correction, sharpness processing, and dodging (compression/decompression of a dynamic range maintaining an intermediate tone).

Such image processing methods may be known methods. Processing conditions for the image processing are set so as to provide an optimum image of a main subject.

While an image is reproduced with a processing condition based on the information on a main subject in the foregoing examples, an sorting and editing of the image data of a moving image can be performed efficiently by use of various types of processing using the information on the main subject, in accordance with the invention.

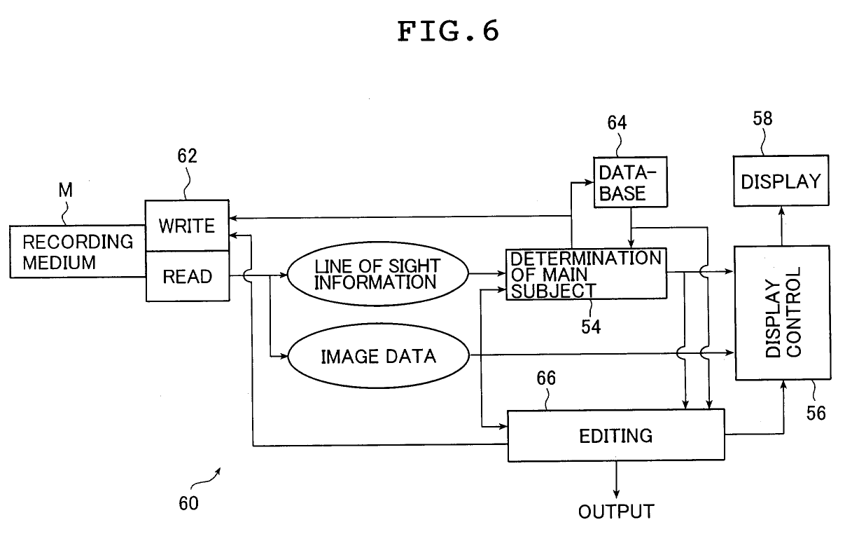

FIG. 6 shows the concept of an exemplary image processor according to the invention.

The image processor 60 shown in FIG. 6 (hereinafter referred to as a processor 60) reads image data and line of sight information from a recording medium M on which the image data of a shot image and the line of sight information, such as a recording medium M on which an MPEG-format image file and line of sight information are recorded in association with each other by the camera 10, same as the reproducing player 50. The processor 60 applies various types of processing. The processor 60 basically comprises a data input/output section 62, a (main subject) determination section 54, a display controller 56, a display section 58, a database 64, and an editing section 66.

In the regenerator 60 shown, the determination section 54, the display controller 56 and the display unit 58, as well as display of the image read from the recording medium M are same as those in the reproducing player 50. Thus the same signs are assigned to the same areas and description is basically made on different areas.

The data input/output section 62, same as the data reading section 52 of the reproducing player 50, reads image data and line of sight data from the recording medium M and supplies those data, as well as writes various types of information supplied from the determination section 54 and the editing section 66 onto the recording medium M. Thus, the input/output section 62 comprises a drive compatible with the recording medium M.

In the processor 60, the image data read by the data input/output section 62 is supplied to not only the determination section 54 and the display controller 56 but also to the editing section 66 as required.

In the processor 60, the determination section 54 supplies the determination result of a main subject not only to the display controller 56 but also supplies (writes) the result to the data input/output section 62, the database 64, and the editing section 66.

In the processor 60, the determination section 54 may supply the determination result of the main subject, for example the information (the second information) on the main subject (including “the main subject is not present) or the name and attribute of the main subject acquired from the database 64 mentioned later for recording such information onto the recording medium M. This facilitates subsequent retrieval of or various processing on a moving image by the recording medium.

The database 64 registers information on the subject and is used by the data input/output section 62 and the editing section 66 to write various types of information.

For example, a person who may be shot with a camera 10 such as a face of a family member is registered into the database 64 and the determination section 54 which has determined a main subject compares the main subject with the information registered in the database 64 to determine who the main subject is.

The photography history of a photographer may be recorded into the database 64 for retrieval of the information on the main subject.

For example, the information on subjects related to the photographer is acquired from the data base using the photography history of the photographer and the information on the determined main subject is selected in the determination section 43. Or, each pieces of information is displayed on the display section 58 for the user of the processor 60 to select desired information using the photography history of the photographer.

The photography history is for example the time information, position information using a GPS, a specific target including a mountain, a car, a building and a flower. For example, it is possible to assume a subject by using the position information during a travel. To use a specific target, similar shapes are displayed to specify the target, thus making an aggregation of subjects of the same type available as subject information.

Determination of the photographer may be input to the processor 60 by way of a known method.

In this practice, the iris of a photographer may be used to identify the photographer and the information on who the photographer is may be acquired from the database 64.

For example, a function to read the iris of a photographer who observes the LED 28 as a finder is incorporated into the camera 10. The information on the iris as well as the image data and line of sight information is recorded onto the recording medium M. Meanwhile, the databases 64 stores the iris information and the information on the corresponding photographers in association. This identifies the photographer who shot the moving image stored on the recording medium.

A main subject identified using the database 64 and the information on the main subject and the photographer acquired from the database 64 are supplied for example to the data input/output section 62 and appended to the image data of a corresponding moving image recorded on the recording medium M. Such information is also supplied to the editing section 66 and appended to the image data of the edited moving image.

In case the main subject determined by the determination section 54 is not registered in the database 64, the main subject may be registered, together with the attribute of the image data, into the database 64 for later retrieval of information.

In the processor 60, the database may be prepared per photographer and databases may be switched depending on the photographer.

Determination of a photographer for switchover between databases may be input by the user of the photographer 60 by way of a known method or a photographer may be automatically selected using the information on the iris of the photographer mentioned earlier.

The editing section 66 is a portion which edits the image data read by the data input/output section 62 from the recording medium M by using various types of information recorded in the database 64 as required, depending on the determination result of the main subject by the determination section 54.

For example, as mentioned earlier, only a scene where a main subject can be identified (and a predetermined number of frames preceding and following the scene) may be extracted from the image data of a moving image and the extracted data may be edited into the image data of a single moving image. Scenes where the same main subject is present may be gathered from a plurality of moving images where the same main subject is present and the scenes may be edited into the image data of a single moving image. As mentioned earlier, the information on the main subject or photographer may be acquired from the database 64 and the information may be incorporated into a moving image as captions or illustrations.

The image data of a moving image thus edited may be supplied to the data input/output section 62 and recorded into the free space of the recording medium M from which the image data has been read or another recording medium M. The image data may be output by the editing section 66 onto various recording media or a computer, or supplied to the display controller 56 to reproduce of the moving image on the display section 58.

An exemplary method determines an index image and appends the index image for example to the image data of a moving image for quick reference in order to perform preferable sorting and storage of the image data of an image.

Generally, the image of the head frame (head image) is used as the index image of the image data of a moving image. However, the head frame of a moving image is often a coincidentally photographed image and not proper as an index image.

According to the invention, the main subject information by way of the determination section 54 is used to select a frame where a subject identified as a main subject first appears or a frame where the main subject appears in largest size in order to readily and quickly determine an index image properly indicating the moving image.

In the processor 60, determination of such an index image is made by the editing section 66. As mentioned earlier, an index image may be determined based on the image data supplied from the data input/output section 62 and the information on the main subject supplied from the determination section 54. Then the image data of the frame is extracted (or image data of a predetermined size may be generated).

The image data of an index image may be supplied to the data input/output section 62 and recorded by the editing section 66 into the recording area for the index image on the recording medium for recording information. The image data may be supplied to the display controller 56 to display the index image, or an index print may be output by a printer (not shown).

This readily and properly performs sorting and storage of moving images.

It is needless to say that the editing of the image data of a moving image and determination of an index image are preferably available on the reproducing player 50 shown in FIG. 4 as mentioned earlier.

As understood from the foregoing description, according to the invention, by determining a main subject by using image data and line of sight information from a recording medium, or recording image data and information on the main subject on the recording medium, it is possible to efficiently edit and reproduce a moving image (image data) with particular emphasis on an important scene as well as store/manage the image data and provide prints, including the operations: detection of a target scene where the main subject is present, reproducing/editing of the images with particular emphasis on the main subject, processing of the images with particular emphasis on the main subject, and determination of an index image using the main subject. Thus it is possible to fully utilize precious image data.

While the foregoing examples utilize the invention for the image data of a motion image, the invention is not limited thereto but may be applied to a still image also. In this practice, same as the foregoing examples, the line of sight of the photographer in photography shooting may be detected and the line of sight information may be recorded into the header of an image file for later determination of a main subject based on the image data and the line of sight information. Or, the main subject may be detected from the line of sight information and the information on the main subject may be recorded into the header of an image file.

In this way, by detecting a main subject from a still image, it is possible, in particular, to read various types of information registered in the database 64 by using the information on the main subject and add the information including the name of the main subject to the image data (image file), which enables to sort and store/manage the image data of still images.

While the image pickup apparatus, main subject determination apparatus and image processor of the invention have been detailed, the invention is not limited to the foregoing examples, and various improvements or changes may be made without departing from the scope of the invention.

As detailed hereinabove, according to the invention, it is possible to detect a target scene, reproduce/edit images, process the images, and determine an index image with particular emphasis on the main subject for the image data of a moving image and a still image. Thus it is possible to efficiently edit and reproduce image data with particular emphasis on an important scene as well as store/manage the image data and provide prints. Thus it is possible to fully utilize precious image data.

What is claimed is:

1. An image pickup apparatus comprising:
a solid-state image pickup device,
a display which shows a scene to be confirmed by a photographer for a record, the scene shot by the solid-state image pickup device,
line of sight detection means for detecting a line of sight of the photographer toward a main subject of the scene on the display, and
recording means for recording the image data of a moving image shot by the solid-state image pickup device and at least one of first information on the line of sight detected by the line of sight detection means when the moving image was shot and second information on the main subject detected from the first information onto a recording medium, the image data and at least one of the first information and the second information corresponding each other.

2. The image pickup apparatus according to claim 1, wherein the line of sight detection means has:
a light source which emits infrared light toward an eye of the photographer,
a light splitter which divides the infrared light reflected on the eye of the photographer and a visible light,
a focusing lens which focuses the divided infrared light, and
a sensor which senses the focused infrared light on a light receiving surface.

3. The image pickup apparatus according to claim 2, wherein the light receiving surface of the sensor and a displaying surface of the display are arranged in optically equivalent positions with respect to an optical axis of the focusing lens.

4. The image pickup apparatus according to claim 1, wherein the first information on the line of sight is information on a position of an eye-cast point of the photographer on a displaying surface of the display.

5. A main subject determination apparatus comprising:
a solid-state image pickup device;
a display which shows a scene to be confirmed by a photographer for a record, the scene shot by the solid-state image pickup device,
line of sight detection means for detecting a line of sight of the photographer toward a main subject of the scene on the display, and
detection means for detecting the main subject of a shot moving image from a image data of the moving image shot by the solid-state image pickup device and first information on the line of sight detected by the line of sight detection means when the moving image was shot.

6. The main subject determination apparatus according to claim 5, wherein the line of sight detection means has:
a light source which emits infrared light towards an eye of the photographer,
a light splitter which divides the infrared light reflected on the eye of the photographer and a visible light,
a focusing lens which focuses the divided infrared light, and
a sensor which senses the focused infrared light on a light receiving surface.

7. The main subject determination apparatus according to claim 6, wherein the light receiving surface of the sensor and a displaying surface of the display are arranged in optically equivalent positions with respect to an optical axis of the focusing lens.

8. The main subject determination apparatus according to claim 5, wherein the first information on the line of sight is information on a position of an eye-cast point of the photographer on a displaying surface of the display.

9. An image processor comprising:
acquisition means for acquiring the image data of a photoelectrically shot image and first information on a line of sight of a photographer toward a main subject of the image when the photographer shot the image; and
determination means for determining the main subject from an image carried by the image data by using the image data and the first information acquired by the acquisition means.

10. The image processor according to claim 9, wherein the
line of the sight is detected by an apparatus which has:
a light source which emits infrared light towards an eye of the photographer,
a light splitter which divides the infrared light reflected on the eye of the photographer from a visible light,
a focusing lens which focuses the divided infrared light, and
a sensor which senses the focused infrared light on a light receiving surface.

11. The image processor according to claim 10, wherein the light receiving surface of the sensor and a displaying surface of the display are arranged in optically equivalent positions with respect to an optical axis of the focusing lens.

12. The image processor according to claim 9, wherein the first information on the line of sight is information on a position of an eye-cast point of the photographer on the shot image when the photographer shoots a scene.

13. The image processor according to claim 10, wherein the image data is a data of a moving image.

14. The image processor according to claim 13, wherein the first information on the line of sight acquired with the image data is corresponding to each frame of the moving image.

15. An image processor comprising:
extraction means for extracting an image where a main subject is on by using the image data of a photoelectrically shot image and first information on a line of sight of a photographer toward the main subject of the shot image; and
image processing means for applying processing to the image data with a processing condition based on the extracted main subject.

16. The image processor according to claim 15, wherein the line of the sight is detected by an apparatus which has:
a light source which emits infrared light towards an eye of the photographer,
a light splitter which divides the infrared light reflected on the eye of the photographer and a visible light,
a focusing lens which focuses the divided infrared light, and
a sensor which senses the focused infrared light on a light receiving surface.

17. The image processor according to claim 16, wherein the light receiving surface of the sensor and a displaying surface of the display are arranged in optically equivalent positions with respect to an optical axis of the focusing lens.

18. The image processor according to claim 15, wherein the first information on the line of sight is information on a position of an eye-cast point of the photographer on the shot image when the photographer shoots a scene.

19. The image processor according to claim 15, wherein the image data is the image data of a moving image.

20. The image processor according to claim 15, wherein the image processing means performs at least one of the following processing types: image processing to reproduce an optimized moving image or an optimized still image of the main subject, image processing to reproduce a moving image with a processing condition based on a frame where the main subject is on, and selection of an index image based on the main subject.
